(19) United States
(12) Patent Application Publication
(10) Pub. No.: US 2024/0157758 A1
(43) Pub. Date: May 16, 2024

(54) INDIRECT REFRIGERANT COOLER

(71) Applicant: MAHLE International GmbH, Stuttgart (DE)

(72) Inventors: Markus Boger, Stuttgart (DE); Matthias Jung, Stuttgart (DE)

(21) Appl. No.: 18/388,811

(22) Filed: Nov. 10, 2023

(30) Foreign Application Priority Data
Nov. 11, 2022 (DE) 10 2022 212 007.8
Dec. 7, 2022 (DE) 10 2022 213 181.9

(51) Int. Cl. B60H 1/00; B60H 1/32

(52) U.S. Cl. CPC B60H 1/00392; B60H 1/00278; B60H 1/3227; B60H 1/3228

(57) ABSTRACT

A battery-electric vehicle is disclosed. The vehicle includes a vehicle interior, an electric motor drivetrain, and a traction battery. An air-conditioning system for air-conditioning the vehicle interior is provided. A drive cooling circuit carrying a drive coolant for cooling the drivetrain is provided. A battery cooling circuit carrying a battery coolant for cooling the traction battery is provided. A refrigeration circuit carrying a refrigerant is provided. The refrigeration circuit includes a high-pressure side, a low-pressure side, a compressor for driving and compressing the refrigerant, a refrigerant cooler for cooling the refrigerant, at least one expansion valve for expanding the refrigerant and an internal heat exchanger.

### CROSS-REFERENCE TO RELATED APPLICATIONS

This application claims priority to German Application No. DE 10 2022 213 181.9 filed on Dec. 7, 2022 and German Application No. DE 10 2022 212 007.8 filed on Nov. 11, 2022, the contents of which are hereby incorporated by reference in their entireties and for all purposes.

### TECHNICAL FIELD

The present invention relates to a battery-electric vehicle.

### BACKGROUND

A battery-electric vehicle comprises in the usual manner a vehicle interior for at least one person (male/female/diverse), which can be the driver (male/female/diverse) and optionally at least one passenger (male/female/diverse). The vehicle is equipped with an electric-motor drivetrain, which includes at least one electric motor, and with a traction battery for the energy supply of the drivetrain. Further, such a vehicle is usually equipped with an air-conditioning system for air-conditioning the vehicle interior, which comprises at least one interior cooler, which serves for cooling a room air flow leading to the vehicle interior and for this purpose can be flowed through by the said room air flow. Further, such a vehicle can be equipped with a drive cooling circuit carrying a drive coolant for cooling the drivetrain, which comprises a drive cooler, which can be flowed through by the drive coolant and by a cooling air flow. Additionally or alternatively to the drive cooling circuit, a battery cooling circuit carrying a battery coolant for cooling the battery can be provided, which comprises a battery cooler, which can be flowed through by the battery coolant.

The present invention deals with the problem of showing for a battery-electric vehicle of the type mentioned above an improved or at least another embodiment which is characterised by improved cooling. The improved cooling can arise through a higher cooling output and/or a more efficient cooling and/or an efficient cooling with limited peripheral conditions and/or additional functions.

According to the invention, this problem is solved through the subject of the independent claim(s). Advantageous embodiments are subject of the dependent claims.

### SUMMARY

The invention is based on the general idea of additionally equipping the battery-electric vehicle with a refrigeration circuit, with the help of which the heat transfer from the vehicle heat sources to the environment is improved. With the help of the refrigeration circuit, greater temperature differences can be achieved at the respective place of the heat transfer, which favours the heat transfer. The refrigeration circuit carries a refrigerant and comprises a high-pressure side, a low-pressure side, a compressor for driving and compressing the refrigerant, a refrigerant cooler for cooling the refrigerant, and at least one expansion valve for expanding the refrigerant. While a coolant, such as for example the drive coolant and the battery coolant, in the usual operating temperature range is present in single phase, preferentially in the liquid state, throughout the cooling circuit, the refrigerant in the refrigeration circuit is present in two phases, namely liquid and gaseous, wherein the gaseous refrigerant is liquefied on the high-pressure side and the liquid refrigerant evaporated on the low-pressure side. Through the evaporation of the liquid refrigerant, an extremely large amount of heat can be absorbed; while during the liquefaction or condensation of the refrigerant a very large amount of heat can be dissipated.

The refrigeration circuit can optionally comprise an internal heat exchanger which couples the high-pressure side with the low-pressure side or the predominantly liquid refrigerant of the high-pressure side with the predominantly gaseous refrigerant of the low-pressure side in a heat-transferring manner.

The respective expansion valve is connected on the inlet side to the high-pressure side and on the outlet side to the low-pressure side, while the compressor is connected on the inlet side to the low-pressure side and on the outlet side to the high-pressure side. The refrigerant cooler can be flowed through by the refrigerant and is arranged on the high-pressure side, in particular upstream of the internal heat exchanger.

Particularly practical, now, is a configuration in which the battery cooler is incorporated downstream of the respective expansion valve and upstream of the internal heat exchanger into the refrigeration circuit and can be flowed through by the refrigerant. Thus, the battery cooler can be flowed through by the refrigerant and by the battery coolant in a media-separated manner. Additionally or alternatively, the interior cooler can be incorporated downstream of the respective expansion valve and in particular upstream of the internal heat exchanger into the refrigeration circuit and can be flowed through by the refrigerant. Thus, the interior cooler can be flowed through by the refrigerant and by the room air flow in a media-separated manner.

Particularly advantageously, now, is a configuration in which the refrigeration circuit additionally comprises an after-cooler, which couples the refrigeration circuit to the drive cooling circuit in a heat-transferring manner. For this purpose, the after-cooler is arranged downstream of the refrigerant cooler and upstream of the battery cooler and in particular upstream of the internal heat exchanger in the refrigeration circuit and can be flowed through by the refrigerant, wherein this after-cooler is additionally incorporated in the drive cooling circuit downstream of the drive cooler and upstream of the heat sources of the drivetrain and can be additionally flowed through by the drive coolant. With the help of this after-cooler it is possible, in particular, to extract additional heat from the refrigerant downstream of the refrigerant cooler before it reaches the battery cooler or the interior cooler. This additional cooling or after-cooling of the refrigerant is advantageous in particular when with stationary vehicle, during a charging operation of the traction battery, comparatively much heat has to be dissipated via the battery cooling circuit, when at the same time because of the stationary vehicle the cooling air flow cannot be generated by the headwind. In order to be able to generate a cooling air flow even with stationary vehicle, a vehicle is usually equipped with a fan. For a strong cooling air flow, the fan for this purpose has to be operated with high output, which is accompanied by a correspondingly high noise emission. Since in battery-electric vehicles the charging operation frequently takes place overnight and in a residential area, a high noise emission is undesirable, so that the fan can only be operated with reduced output. Through the after-cooling of the refrigerant with the after-cooler, an adequate heat dissipation to the environment can now be realised even with reduced fan output and thus with a moderate cooling air flow, since for this purpose the drive cooling circuit can be co-utilised, the cooling output of which with stationary vehicle is not usually needed. By way of the after-cooler proposed here, which couples the refrigeration circuit to the drive cooling circuit in a heat-transferring manner, an adequate cooling for the traction battery can thus be provided for a charging operation even with reduced fan output.

The refrigeration circuit can comprise a refrigerant collector for storing refrigerant. Particularly advantageous is an embodiment, in which such a refrigerant collector is integrated in the internal heat exchanger on the low-pressure side. This is thus a combined component with an internal flow control, in which the refrigerant within the component on the low-pressure side initially flows into the refrigerant collector before it subsequently flows through the low-pressure part of the internal heat exchanger.

Practically, the vehicle can comprise a cooling fan, which with stationary vehicle generates the cooling air flow and with travelling vehicle, supports the cooling air flow. As explained above, this cooling fan, during the charging of the vehicle, can be operated with reduced output in order to avoid elevated noise emission in the surroundings.

Practically, the refrigerant cooler and the drive cooler can be arranged so that they can be flowed through by the same cooling air flow one after the other. By way of this series connection of refrigerant cooler and drive cooler, a particularly compact arrangement can be realised which requires less installation space on the vehicle. In principle, however, a parallel connection of the two coolers is also conceivable so that they can be flowed through in parallel by the cooling air flow. This parallel connection is preferred in particular when adequate installation space is available on the vehicle.

Preferred is a configuration, in which the drive cooler and the refrigerant cooler are arranged in a front end of the vehicle. Front end coolers in the case of travelling vehicle can be more easily flowed through by a cooling air flow generated by the headwind.

Advantageous is an embodiment, in which the drive cooler, with respect to the cooling air flow, is arranged upstream of the refrigerant cooler on or in the vehicle. It has been shown that with this configuration, at least with travelling vehicle, altogether more heat can be dissipated to the environment.

According to an embodiment, the after-cooler can be incorporated in the drive cooling circuit so that the entire volume flow of the drive coolant flows through the after-cooler. With this configuration, the complete volume flow of the drive coolant permanently flows through the after-cooler during the operation of the drive cooling circuit.

Alternatively to this, it can be provided in another embodiment that the drive cooling circuit comprises an after-cooling bypass which, on the side of the drive cooling circuit, bypasses the after-cooler so that the volume flow of the drive coolant can at least partially flow through the after-cooler and/or at least partially through the after-cooler bypass. Thus, a flow of drive coolant through the after-cooler that is in particular as required can be realised.

According to a further embodiment, the drive cooling circuit can comprise in the after-cooler bypass a stop valve for the shutting-off of the after-cooler bypass as required. Alternatively to this, the drive cooling circuit, in an inflow to the after-cooler, can comprise a stop valve for blocking the inflow as required. With the after-cooler bypass shut off, the entire volume flow of the drive coolant flows through the after-cooler. It is likewise conceivable to arrange the stop valve in an outflow of the after-cooler. With shut-off inflow and with shut-off outflow, the entire volume flow of the drive coolant flows through the after-cooler bypass. Preferably, the stop valve is arranged in the after-cooler bypass since with opened stop valve the flow resistance of the after-cooler ensures that the drive coolant flows almost entirely through the after-cooler bypass.

In an alternative further development, the drive cooling circuit can comprise a control valve with which a division of the volume flow of the drive coolant into the after-cooler and into the after-cooler bypass is adjustable as required. This can be for example a 3/2-way valve which can be additionally configured as proportional valve. In this way, the flow of drive coolant through the after-cooler can be adjusted as required. Practically, the control valve can connect the drive cooling circuit to the inflow of the after-cooler and to the after-cooler bypass. It is likewise conceivable that the control valve connects the drive cooling circuit to the outflow of the after-cooler and to the after-cooler bypass.

In the present context, a “configuration” is synonymous with a “configuration”. In particular, the formulation “configured so that” is synonymous with the formulation “configured so that”.

According to another advantageous embodiment, the refrigeration circuit can be configured so that the interior cooler and the battery cooler can be flowed through by refrigerant in parallel. In particular, the refrigeration circuit for this purpose can comprise an interior cooling branch in which the interior cooler is arranged, which at a branch point, branches off from the high-pressure side, which is arranged on the high-pressure side downstream of the internal heat exchanger and upstream of the battery cooler. The interior cooling branch is additionally returned at a return point into the low-pressure side, which is arranged on the low-pressure side downstream of the battery cooler and upstream of the internal heat exchanger. In this way, the interior cooler and the battery cooler are flowed through by the refrigerant in the refrigeration circuit in parallel. In particular, the volume flows of the refrigerant through the battery cooler and through the interior cooler in conjunction with suitable control valves, can be adjusted independently of one another as required.

According to an advantageous further development, the refrigeration circuit can comprise at least two expansion valves, namely a first expansion valve and a second expansion valve, wherein the first expansion valve is arranged downstream of the branch point and upstream of the battery cooler, while the second expansion valve is arranged downstream of the branch point and upstream of the interior cooler. By way of the two expansion valves, both the battery cooler and also the interior cooler act as evaporators for the refrigerant. Through the separate expansion valves, the cooling output for the respective cooler can be optimised. In particular, battery cooler and interior cooler can be dimensioned differently.

In another embodiment, the refrigeration circuit can comprise a bypass branch which in the refrigeration circuit bypasses the after-cooler, the internal heat exchanger on the high-pressure side and the battery cooler and also the interior cooler. Thus, it is possible to operate the refrigeration circuit as heat pump, for example in order to supply a heat exchanger operating as heater, such as for example an interior heater, with refrigerant, which is heated through the compression in the compressor. Practically, the refrigeration circuit in the bypass branch can comprise a stop valve for blocking and opening the bypass branch.

According to an advantageous further development, the refrigeration circuit can comprise a non-non-return check valve, which is arranged between a branch-off point, at which the bypass branch branches off upstream of the after-cooler, and the after-cooler, and the blocking direction of which leads from the after-cooler in the direction of the branch-off point. The opening direction of the non-non-return check valve is opposed to the blocking direction and leads from the branch-off point to the after-cooler.

Particularly practical is a configuration, in which the non-non-return check valve is preloaded with a preload into its blocking position which is selected so that the non-non-return check valve in its passage direction only opens from a predetermined opening pressure which is higher than the low pressure of the refrigeration circuit and lower than the high pressure of the refrigeration circuit.

In a further development, the refrigeration circuit can additionally comprise an interior heating branch, which on the high-pressure side branches off from a control valve which is arranged upstream of the refrigerant cooler and which controls the flow of the refrigerant through the interior heating branch. This interior heating branch can now additionally comprise an interior heater, which can be flowed through by the room air flow and by the refrigerant. Upstream of the refrigerant cooler, the refrigerant is still heated because of the compression by the compressor, so that via the interior heater, heat from the refrigerant can be passed on to the room air flow. In this case, the refrigeration circuit is used as heat pump in order to be able to efficiently heat the vehicle interior. The energetic efficiency of such a heat pump is better than that of an electrical heating of the room air flow, for example by means of an electrically heated heat exchanger, which is arranged downstream of the interior cooler and can be flowed through by the room air flow.

Practically, the interior cooler and the interior heater can be arranged so that they can be flowed through by the same room air flow. It can be provided, in particular that the interior cooler with respect to the room air flow is arranged upstream of the interior heater in or on the vehicle.

According to a particularly advantages embodiment, the refrigeration circuit can comprise a connecting branch which via a first connecting point branches off from the high-pressure side, which is arranged on the high-pressure side downstream of the interior heater and upstream of the refrigerant cooler. The connecting branch can be introduced into the high-pressure side via a second connecting point, which is arranged on the high-pressure side downstream of the internal heat exchanger and upstream of the interior cooler. Practically, the connecting branch additionally comprises a control valve for adjusting a volume flow of the refrigerant through the connecting branch. With the help of the connecting branch and of the associated control valve, the interior cooler and/or the battery cooler, with activated interior heating branch, can be activated as required for example in order to dry the room air flow, in particular before it flows through the interior heater, and/or in order to dissipate heat from the battery. It can be provided in particular that the second connecting point is arranged on the interior cooling branch, i.e. between the interior cooler and the branch point, which branches the refrigeration circuit in the cooling mode on the high-pressure side into the battery cooler and the interior cooler. In the heating mode, by contrast, the second connecting point represents the branching of the refrigeration circuit into the battery cooler and into the interior cooler, which can be optionally activated. According to an advantageous embodiment, a controllable throttle valve can be arranged in the refrigeration circuit between the first connecting point and the refrigerant cooler, which can be switched between a throttling state and a passage state. The throttle valve is additionally configured so that in the throttling state it functions as further expansion valve which is connected on the inlet side to the high-pressure side containing the interior heater and on the outlet side to the low-pressure side containing the refrigerant cooler. Apart from this, the refrigerant cooler can be configured so that in the throttling state of the throttle valve it functions as evaporator for heating the refrigerant. Further, the throttle valve is practically configured so that in the passage state it can be flowed through by the refrigerant and on the inlet side and on the outlet side is connected to the high-pressure side. The flow through the throttle valve in the passage state takes place quasi without back pressure, i.e. without pressure loss worth mentioning. With the help of the controllable throttle valve it is thus possible to use the refrigerant cooler for a cooling operation of the refrigeration circuit for cooling the refrigerant and for a heating operation of the refrigeration circuit for heating the refrigerant.

In a special embodiment, the refrigeration circuit can again comprise an interior heater, which on the high-pressure side comprises an advance and a return, wherein the advance of the interior heater is connected to the compressor while the return of the interior heater is connected to a switching valve. In addition, the switching valve is connected to a cooling path and to a heating path. The switching valve can be switched over between a cooling position and a heating position and for this purpose can be configured in particular as 3/2-way valve. In the cooling position, the switching valve conducts the refrigerant coming from the return through the cooling path. In the heating position, the switching valve conducts the refrigerant coming from the return through the heating path. The cooling path can now lead from the switching valve to the refrigerant cooler while the heating path leads from the switching valve to a collector inlet of a refrigerant collector on the high-pressure side. The refrigerant collector serves for collecting, storing and calming the refrigerant and is arranged on the high-pressure side.

Further, the refrigeration circuit can comprise an after-cooling path, which leads from the refrigerant cooler to the collector inlet and in which the after-cooler is arranged. Further, the cooling circuit can comprise and expansion path which is connected to a collector outlet of the refrigerant collector and is additionally connected to the after-cooling path between the refrigerant cooler and the after-cooler. In the expansion path, a further expansion valve is arranged. Further, the refrigeration circuit can comprise a heat exchanging path, which leads from the collector outlet to the internal heat exchanger. Apart from this, the refrigeration circuit can comprise a bypass path which connects a first branch point, which is formed on the cooling path between the refrigerant cooler and the switching valve, to a second branch point, which is formed on the low-pressure side between the internal heat exchanger and the compressor. This bypass path comprises a stop valve which can be switched between a blocking position for blocking a volume flow of refrigerant through the bypass path and an open position for opening a volume flow of refrigerant through the bypass path.

With the help of a corresponding control, which is at least coupled to the switching valve and the stop valve, the refrigeration circuit can be operated in a cooling mode and in a heating mode. The cooling mode serves for cooling the battery coolant and/or the room air flow. The heating mode by contrast serves for heating the room air flow. The control can now be configured so that for the cooling mode it adjusts the switching valve into its cooling position and the stop valve into its blocking position. In contrast with this, the control, for the heating mode, can adjust the switching valve into its heating position and the stop valve into its open position.

During the cooling operation, the refrigerant flows from the compressor through the interior heater, thereafter through the cooling path, thereafter through the refrigerant cooler, thereafter through the after-cooler, thereafter through the refrigerant collector, thereafter through the internal heat exchanger, thereafter through the battery cooler and/or through the interior cooler and thereafter again to the compressor. In contrast with this, the refrigerant, during the heating operation, flows from the compressor through the interior heater, thereafter through the heating path, thereafter through the refrigerant collector, thereafter through the expansion path, thereafter through the refrigerant cooler, thereafter through the bypass path and then again to the compressor.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the invention defined by the claims. The parts of a higher unit, such as for example an installation device or an arrangement mentioned above and still to be named in the following which are separately denoted, can form separate parts or components of this unit or be integral regions or portions of this unit, even if shown otherwise in the drawings.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically,

FIGS. 1 to 8 a highly simplified schematic representation in the manner of a circuit diagram each of a battery-electric vehicle in different embodiments.

### DETAILED DESCRIPTION

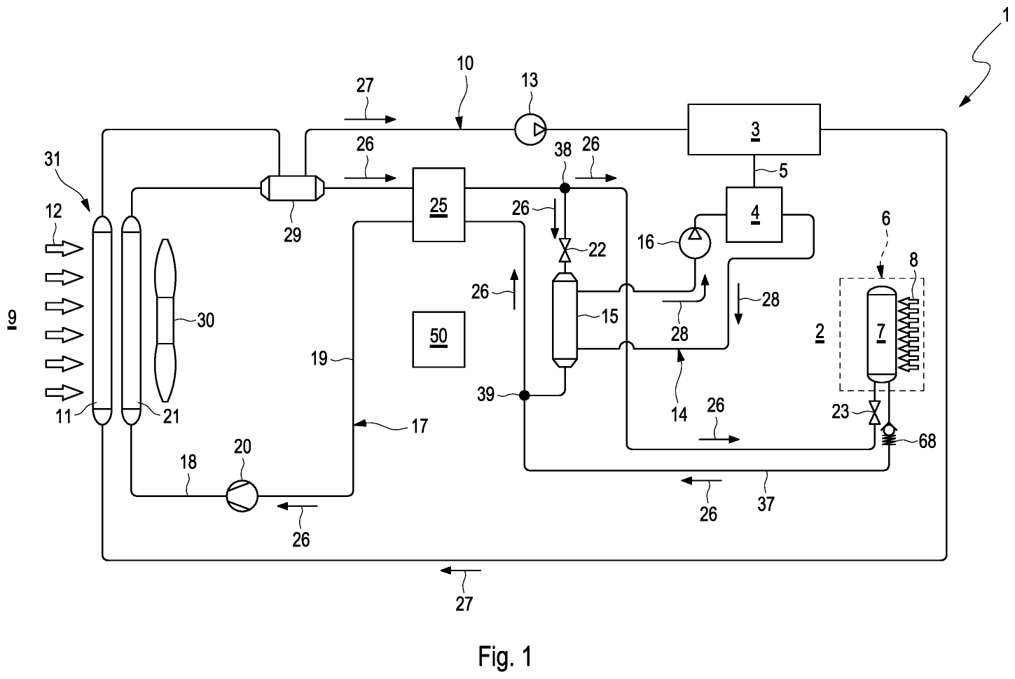

According to the FIGS. 1 to 8, a battery-electric vehicle 1, which can be a passenger car, a commercial vehicle or a two-wheeler, includes a vehicle interior 2 for at least one person, an electric motor drivetrain 3 and a traction battery 4 for the electrical energy supply of the drivetrain 3. For this purpose, the drivetrain 3 and the traction battery 4 are coupled to one another via an electrical connection 5.

Apart from this, the vehicle 1 comprises an air-conditioning system 6 for air-conditioning the vehicle interior 2. The air-conditioning system 6 for this purpose comprises at least one interior cooler 7 which serves for cooling a room air flow 8 leading to the vehicle interior 2 and for this purpose can be flowed through by the said room air flow 8. In the usual manner, the room air flow 8 is fresh air from surroundings 9 of the vehicle 1 or from circulating air from the vehicle interior 2 or any mixture of fresh air and circulating air. It is clear, further, that the air-conditioning system 6 in the usual manner comprises at least one fan for driving the room air flow 8 which is not shown.

The vehicle 1 is additionally equipped with a drive cooling circuit 10, which serves for cooling the drivetrain 3 and which for this purpose carries a drive coolant. The drive cooling circuit 10 comprises a drive cooler 11 which can be flowed through by drive coolant and by a cooling air flow 12, which originates from the environment 9. For driving the drive coolant, the drive cooling circuit 10 comprises a corresponding delivery device 13, which can be configured in particular as coolant pump. The drivetrain 3 comprises at least one heat source which is not shown in more detail, such as for example an electric motor and power electronics, which are coupled to the drive cooling circuit 10 in a heat-transferring manner. A flow direction of the drive coolant in the drive cooling circuit 10 is indicated by arrows 27.

Further, the vehicle 1 is equipped with a battery cooling circuit 14, which carries a battery coolant and which serves for cooling the traction battery 4. For this purpose, the battery cooling circuit 14 comprises a battery cooler 15 which can be flowed through by the battery coolant. For driving the battery coolant, the battery cooling circuit 14 can comprise a corresponding delivery device 16, which can be in particular a coolant pump. The traction battery 4 comprises at least one heat source which is not shown in more detail, such as for example battery cells, which are coupled to the battery cooling circuit 14 in a heat-transferring manner. The drive coolant and the battery coolant can be identical or distinct. In this case, a fluidic connection of the two cooling circuits 10 and 14 which is not shown is optionally also conceivable, so that for example a common collection vessel or storage vessel for the joint coolant can be provided for example for both cooling circuits 10, 14. A flow direction of the battery coolant in the battery cooling circuit 14 is indicated by arrows 28.

The vehicle 1 is additionally equipped with a refrigeration circuit 17 which carries a refrigerant, comprises a high-pressure side 18, a low-pressure side 19, a compressor 20 for driving and compressing the refrigerant, a refrigerant cooler 21 for cooling the refrigerant, at least one expansion valve 22, 23, 24 for expanding the refrigerant and an internal heat exchanger 25. The internal heat exchanger 25 serves for the heat-transferring coupling of the high-pressure side 18 to the low-pressure side 19. It is clear that the refrigerant flows through the internal heat exchanger 25 separately with respect to the high-pressure side 18 and the low-pressure side 19. An embodiment, in which in the internal heat exchanger 25 a refrigerant collector 57 is additionally integrated on the low-pressure side is particularly advantageous. This is thus a combined component with an internal flow control, in which the refrigerant on the low-pressure side 19 initially flows into the refrigerant collector 57 before it subsequently flows through the low-pressure part of the internal heat exchanger 25.

The respective expansion valve 22, 23, 24 is connected on its inlet side to the high-pressure side 18 and on its outlet side to the low-pressure side 19. In contrast with this, the compressor 20 on its inlet side is connected to the low-pressure side 19 and on its outlet side to the high-pressure side 18. A flow direction of the refrigerant in the refrigeration circuit 17 is indicated by arrows 26.

The refrigerant coolant 21 can be flowed through by a cooling air flow 12 and by the refrigerant. The refrigerant coolant 21 is arranged on the high-pressure side 18 upstream of the internal heat exchanger 25. The battery cooler 15 is incorporated in the refrigeration circuit 17, namely on the low-pressure side 19. For this purpose, the battery cooler 15 is incorporated in the refrigeration circuit 17 on the low-pressure side 19 downstream of the respective expansion valve 22 and upstream of the internal heat exchanger 25, so that it can be flowed through by the refrigerant. Through the positioning downstream of the respective expansion valve 22, the battery cooler 15 can be practically configured as evaporator, so that a lot of heat can be transferred from the battery coolant to the refrigerant. It is clear that the battery coolant and the refrigerant flow through the battery cooler 15 separately or media-separately.

The interior cooler 7 is also incorporated in the refrigeration circuit 17, namely likewise on the low-pressure side 19. For this purpose, the interior cooler 7 is incorporated in the refrigeration circuit 17 downstream of the respective expansion valve 23 and upstream of the internal heat exchanger 25, so that it can be flowed through by the refrigerant. Through the positioning of the interior cooler 7 downstream of the respective expansion valve 23, the interior cooler 7 can also be configured as evaporator, so that particularly much heat can be transferred from the room air flow 8 to the refrigerant.

Apart from this, the refrigeration circuit 17 is equipped with an after cooler 29, which is arranged in the refrigeration circuit 17 on the high-pressure side 18 downstream of the refrigerant cooler 21 and upstream of the internal heat exchanger 25 and can be flowed through by the refrigerant. This after-cooler 29 is additionally incorporated in the drive cooling circuit 10, namely downstream of the drive cooler 11 and upstream of the drivetrain 3. Accordingly, the after-cooler 29 can also be flowed through by the drive coolant, namely separately or media-separately with respect to the refrigerant.

The vehicle 1 practically comprises a cooling fan 30, which in the figures is symbolised by a fan wheel. The cooling fan 30 can generate the cooling air flow 12 with stationary vehicle 1. With travelling vehicle 1, the cooling fan 30 can amplify the cooling air flow 12. The drive cooler 11 and the refrigerant cooler 21 are practically arranged in a front end 31 of the vehicle 1. Shown is a particularly compact series arrangement with respect to the cooling air flow 12, so that the refrigerant cooler 21 and the drive cooler 11 can be flowed through by the same cooling air flow 12 in succession. Here, the shown arrangement is preferred, in which the drive cooler 11 with respect to the cooling air flow 12 is arranged upstream of the refrigerant cooler 21.

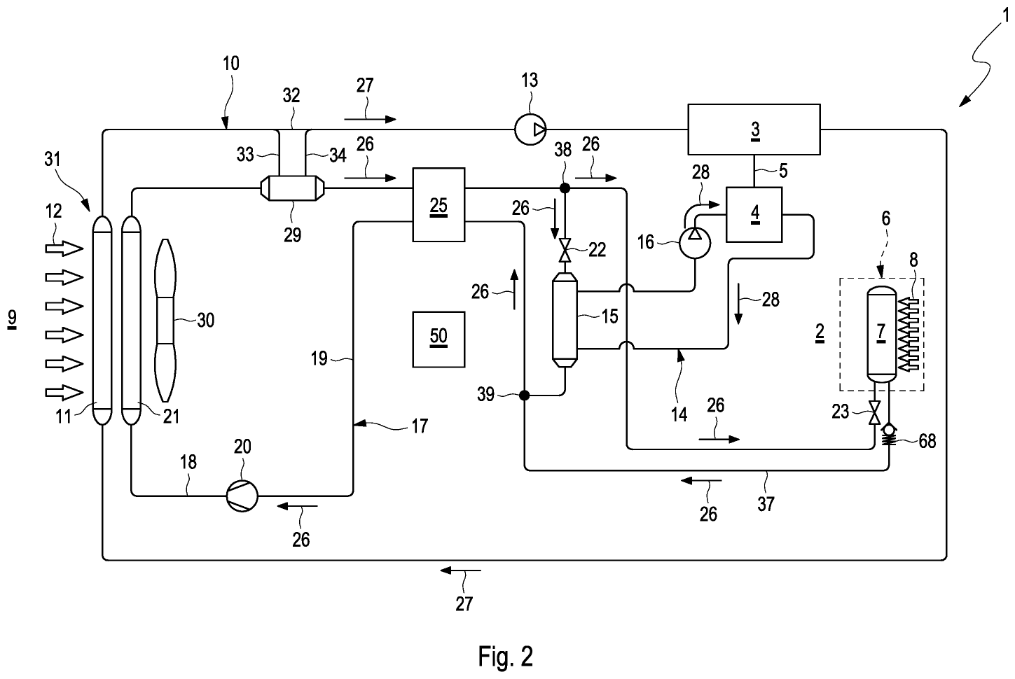

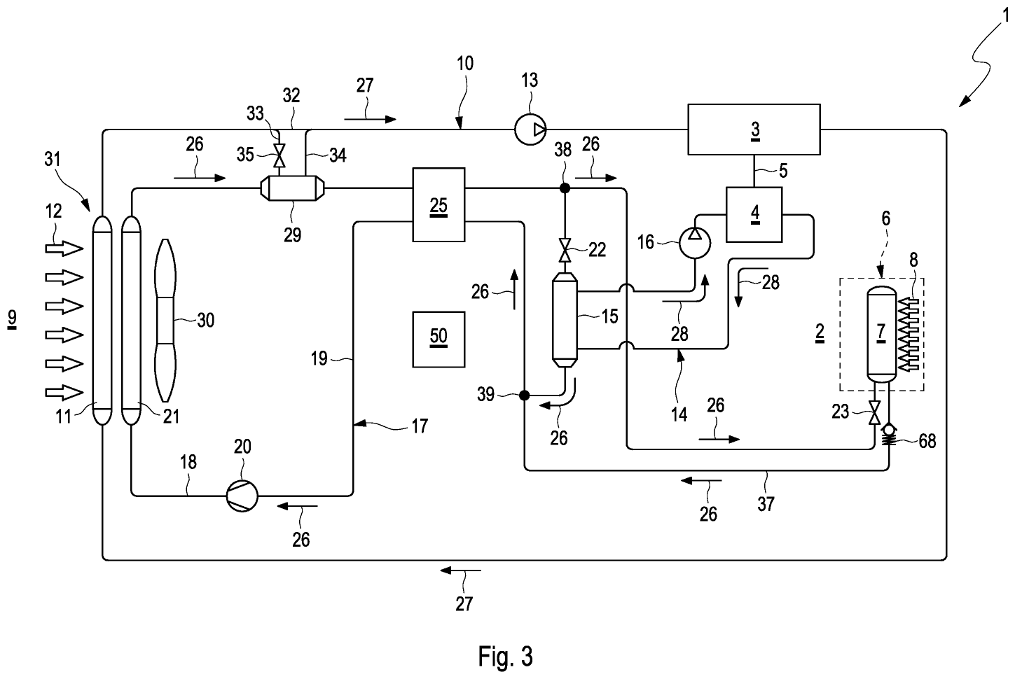

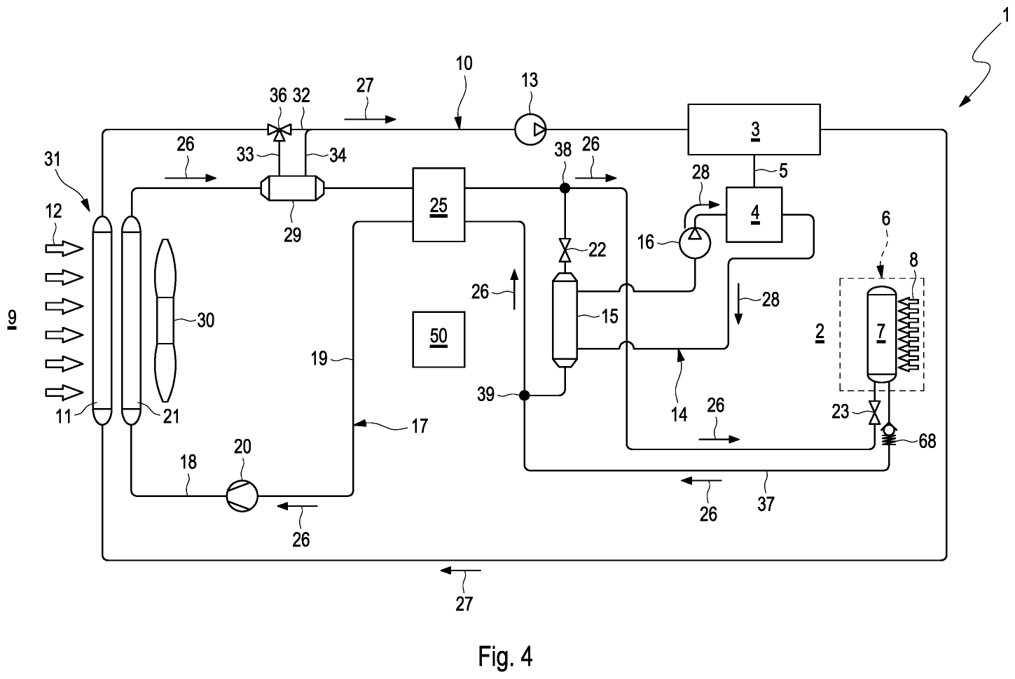

In the embodiment shown in FIG. 1, the after-cooler 29 is incorporated in the drive cooling circuit 10 so that the entire volume flow of the drive coolant always flows through the after-cooler 29. In the embodiments of the FIGS. 2 to 7, the drive cooling circuit 10 comprises an after-cooler bypass 32, which bypasses the after-cooler 29 with respect to the drive coolant. The after-cooler bypass 32 connects an inflow 33 leading to the after-cooler 29 to an outflow 34 coming from the after-cooler 29. Thus, the volume flow of the drive coolant can at least partially flow through the after-cooler 29 and/or at least partially through the after-cooler bypass 32. In the embodiments shown in the FIGS. 2 and 5 to 7, the division of the volume flow of the drive coolant into the after-cooler bypass 32 and into the after-cooler 29 can be adjusted to a predetermined value by a corresponding coordination of the flow resistances on the one hand of the after-cooler 29 and on the other hand of the after-cooler bypass 32. Purely exemplarily and without loss of the generality, the FIGS. 3 and 4 show possibilities as to how the division of the volume flow of the drive coolant into the after-cooler 29 and into the after-cooler bypass 32 can be made variable or adjustable.

According to FIG. 3, a stop valve 35 can be arranged for example in the inflow 33 to the after-cooler 29 with which, depending on demand, the inflow 33 and thus the flow through the after-cooler 29 can be blocked. It is likewise conceivable to arrange the stop valve 35 not in the inflow 33 but in the after-cooler bypass 32, i.e. between the inflow 33 and the outflow 34 of the after-cooler 29, or in the outflow 34.

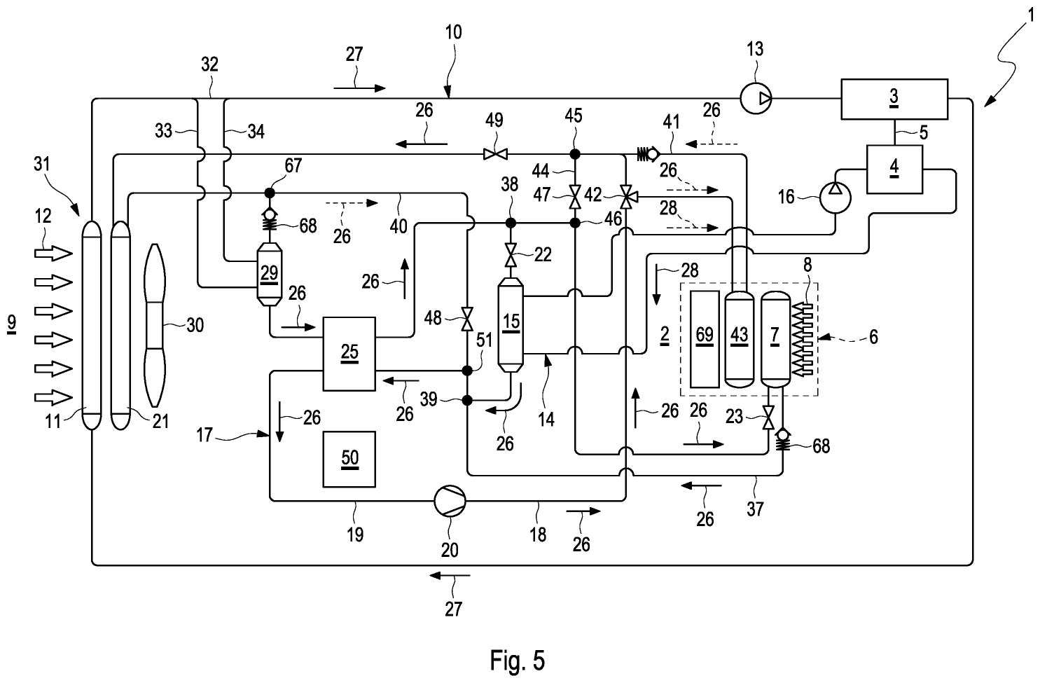

Alternatively to this, a control valve 36 according to FIG. 4 can be employed, with which the division of the volume flow of the drive coolant into the after-cooler 29 and into the after-cooler bypass 32 is adjustable. In the example of FIG. 4, the control valve 36 is arranged on the inflow 33. It is likewise conceivable to arrange the control valve 36 on the outflow 34. The possibilities for varying and adjusting the division of the volume flow of the drive coolant into the after-cooler 29 and into the after-cooler bypass 32 described above with reference to the FIGS. 3 and 4 can also be realised with the embodiments of the FIGS. 5 to 7.

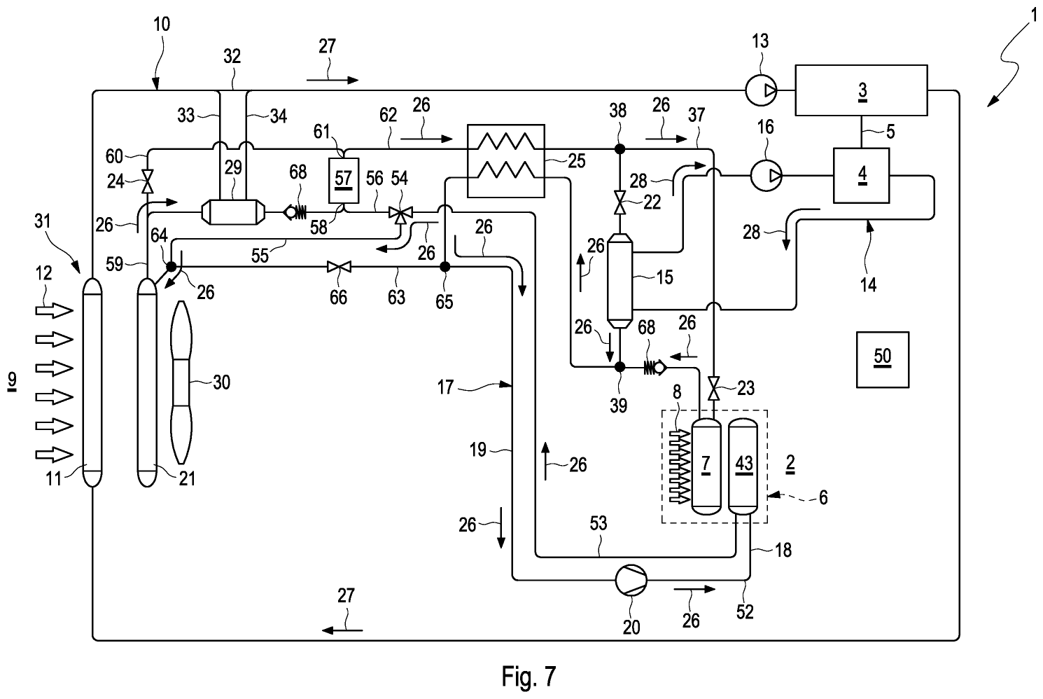

According to the FIGS. 1 to 7, the refrigeration circuit 17 can comprise an interior cooling branch 37. The interior cooler 7 is arranged in this interior cooling branch 37. The interior cooling branch 37 branches off from the high-pressure side 18 at a branch point 38, which in the following can also be referred to as first branch-off point 38, and at a return point 39, which in the following can also be referred to as first introduction point 39, is returned into the low-pressure side 19. The first branch-off point 38 is located on the high-pressure 18 downstream of the internal heat exchanger 25 and upstream of the battery cooler 15. The first return point 39 is located on the low-pressure side 19 downstream of the battery cooler 15 and upstream of the internal heat exchanger 25. Thus, the battery cooler 15 and the interior cooler 7 are connected in parallel with respect to the refrigerant. The refrigeration circuit 17 comprises at least two expansion valves, namely a first expansion valve 22 and a second expansion valve 23. In the embodiment of FIG. 7, a third expansion valve 24 is additionally provided. The first expansion valve 22 is arranged downstream of the first branch-off point 38 and upstream of the battery cooler 15 and makes possible configuring the battery cooler 15 as evaporator for the refrigerant. The second expansion valve 23 is arranged downstream of the first branch-off point 38 and upstream of the interior cooler 7 and makes possible configuring the interior cooler 7 as evaporator for the refrigerant.

In the embodiment shown in FIG. 5, the refrigeration circuit 10 comprises a bypass branch 40, which bypasses the after-cooler 29, the internal heat exchanger 25 on the high-pressure side 18 and the battery cooler 15. Further, the refrigeration circuit 17 is equipped, here, with an interior heating branch 41 which on the high-pressure side 18 branches off from a control valve 42 which in the following can also be referred to as first control valve 42. The first control valve 42 is arranged upstream of the refrigerant cooler 21 and controls the flow of the refrigerant through the interior heating branch 41. The first control valve 42 can be practically designed as 3/2-way valve. In the interior heating branch 42, an interior heater 43 is additionally arranged, which can be flowed through by the room air flow 8 and by the refrigerant. In the example of FIG. 5, the interior cooler 7 and the interior heater 43 are arranged so that they can be flowed through by the same room air flow 8. Further, the arrangement in FIG. 5 takes place so that the interior cooler 7 with respect to the room air flow 8 is arranged on the vehicle 1 upstream of the interior heater 43. As a result, the room air flow is first cooled and then heated. This can be utilised for drying the room air flow. With completely opened first control valve 42, the entire volume flow of the refrigerant flows through the interior heater 43. With completely closed first control valve 42, no refrigerant flows through the interior heater 43, but the entire volume flow of the refrigerant rather bypasses the interior heating branch 41.

According to FIG. 5, the refrigeration circuit 17 can additionally comprise a connecting branch 44, which on a first connecting point 45 branches off from the high-pressure side 18. This first connecting point 45 is located on the high-pressure side 18 downstream of the interior heater 43 and upstream of the refrigerant cooler 21. The connecting branch 44 is returned into the high-pressure side 18 via a second connecting point 46. The second connecting point 46 is located on the high-pressure side 18 downstream of the internal heat exchanger 25 and upstream of the interior cooler 7. In the connecting branch 44, a control valve 47 for adjusting a volume flow of the refrigerant through the connecting branch 44 is arranged, which in the following can also be referred to as second control valve 47. When the second control valve 47 blocks the connecting branch 44, the entire volume flow of the refrigerant downstream of the interior heating branch 41 flows through the refrigerant cooler 21. By opening the second control valve 47 or the connecting branch 44, a flow through the interior cooler 7 and/or the battery cooler 15 can be additionally achieved. The second connecting point 46 in this case can be practically located in the interior cooling branch 37.

In the bypass branch 40, a stop valve 48 can be arranged, with the help of the bypass branch 40 can be opened or closed. The bypass branch 40 connects a branch-off point 67, which in the following is also referred to as second branch-off point 67, with an introduction point 51, which in the following is also referred to as second introduction point 51. This second branch-off point 67 is located between the refrigerant cooler 21 and the after-cooler 29. This second introduction point 51 is located between the first introduction point 39 and the internal heat exchanger 25.

In the embodiment shown in FIG. 5, the refrigeration circuit 17 additionally comprises a controllable throttle valve 49, which is arranged between the first connecting point 45 and the refrigerant cooler 21. The throttle valve 49 can be switched between a throttling state and a passage state. In the throttling state, the throttle valve 49 serves as further expansion valve which on the inlet side is connected to the high-pressure side 18 and on the outlet side to the low-pressure side 19. In the throttling state of the throttle valve 49, the high-pressure side 18 contains the interior heater 43 and the low-pressure side 19 contains the refrigerant cooler 21. The refrigerant cooler 21, in the throttling state of the throttle valve 49, functions as evaporator for heating the refrigerant. In contrast with this, the throttle valve 49 in the passage state can be flowed through by the refrigerant without substantial additional flow resistance, so that the throttle valve 49 on the inlet side and on the outlet side is located on the high-pressure side 18.

In the heating mode or heat pump mode of the refrigeration circuit 17, the bypass branch 40 is opened and the throttle valve 49 is in the throttling state. In the refrigeration circuit 17, a non-non-return check valve 68 is arranged between the after-cooler 29 and the second branch-off point 67, which is preloaded into its blocking position. The preload of the non-non-return check valve 68 is selected so that it opens only from a predetermined opening pressure. This opening pressure is selected so that the non-non-return check valve 68 blocks at low-pressure in the refrigerant and opens at high-pressure in the refrigerant. In the heating mode, the throttle valve 49 throttles the pressure in the refrigerant so that the same falls to the low pressure. Thus, the non-non-return check valve 68 remains closed in the heating mode, so that the refrigerant bypasses the after-cooler 29 and the internal heat exchanger 25. Apart from this, the non-non-return check valve 68, with opened connecting branch 44, prevents a return flow on the high-pressure side through the internal heat exchanger 25 and the after-cooler 29. In the normal cooling mode of the refrigeration circuit 17, the high-pressure is present in the refrigerant at the second branch-off point 67, so that the non-non-return check valve 68 opens and the after-cooler 29 is flowed through, more so since the stop valve 48 then blocks the bypass branch 40.

According to the example of FIG. 5, the air-conditioning system 6 can be additionally equipped with an electric heater 69 which can be flowed through by the room air flow 8. Such an electric heater 69 can also be provided with the other embodiments.

In all embodiments, the refrigeration circuit 17 can comprise a control 50 which in a suitable manner is coupled to controllable components of the refrigeration circuit 17. In the example of FIG. 5, the control 50 is coupled in particular to the first control valve 42, to the second control valve 47 and to the stop valve 48 as well as to the throttle valve 49. For the cooling operation of the refrigeration circuit 17, the control 50 causes the first control valve 42 to block the interior heating branch 41, so that the entire volume flow of refrigerant flows from the compressor 20 to the first connecting point 45. The second control valve 47 blocks the connecting branch 44 so that the entire volume flow of refrigerant flows to the throttle valve 49. In its passage state, the throttle valve 49 is switched so that the entire volume flow of refrigerant flows, unhindered, to the refrigerant cooler where it is cooled. The stop valve 48 blocks the bypass branch 40 so that the refrigerant flows from the refrigerant cooler 21 through the after-cooler 29, thereafter through the internal heat exchanger 25 to the branch-off point 38. From there, the refrigerant flows parallel through the battery cooler 15 and the interior cooler 7 as far as to the return point 39. From there, the refrigerant flows through the internal heat exchanger 25 back to the compressor 20.

For the heating operation, the control 50 causes the first control valve 42 to conduct the refrigerant through the interior heating branch 41 and thus through the interior heater 43. From there, the refrigerant via the first connecting point 45 reaches the throttle valve 49 which is now switched into the throttling state, so that refrigerant flowing to the refrigerant cooler 21 evaporates in the refrigerant cooler 21 and absorbs heat in the process. The stop valve 48 is now opened and the non-non-return check valve 68 between the second branch point 67 and the after-cooler 29, because of its preload into the blocking position, causes the expanded and heated refrigerant to bypass the after-cooler 29 and the internal heat exchanger 25 and at the second introduction point 51 reaches the original low-pressure side 19. The refrigerant then flows through the internal heat exchanger 25 back to the compressor 20.

Provided that during the heating operation a cooling of the battery coolant and/or a drying of the room air flow 8 is desired, the second control valve 47 for opening the connecting branch 44 can be additionally activated, so that a part of the refrigerant flows through the battery cooler 15 and through the interior cooler 7. The control valve 47 can also be configured as stop valve which opens or blocks the connecting branch as required. The partial flows of the refrigerant, which flow through the battery cooler 15 and through the interior cooler 7, unite at the first introduction point 39 and, at the second introduction point 51, unite with the partial flow of the refrigerant flowing through the refrigerant cooler 21. In FIG. 5, the arrows 26 which represent the flow direction of the refrigerant in the interior heating branch 41 during the heating operation, is drawn in with dashed line.

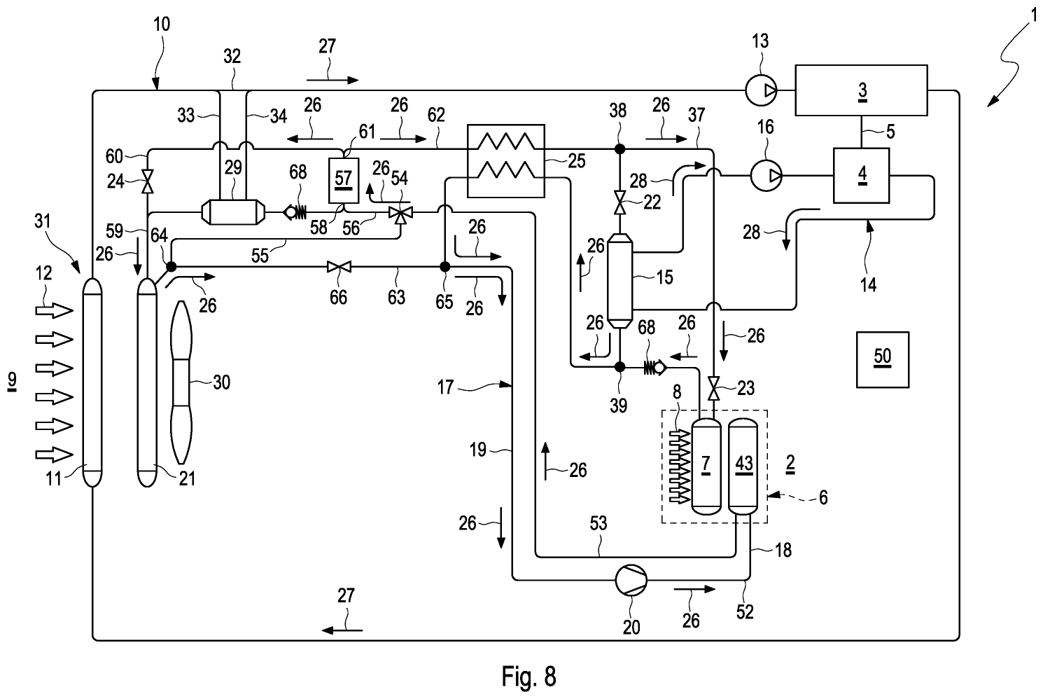

In the following, a special embodiment of the vehicle 1 is explained in more detail with reference to the FIGS. 7 and 8, in which the refrigeration circuit 17 is likewise shown in a cooling mode, which is shown in FIG. 7, and which can be operated in a heating mode which is shown in FIG. 8.

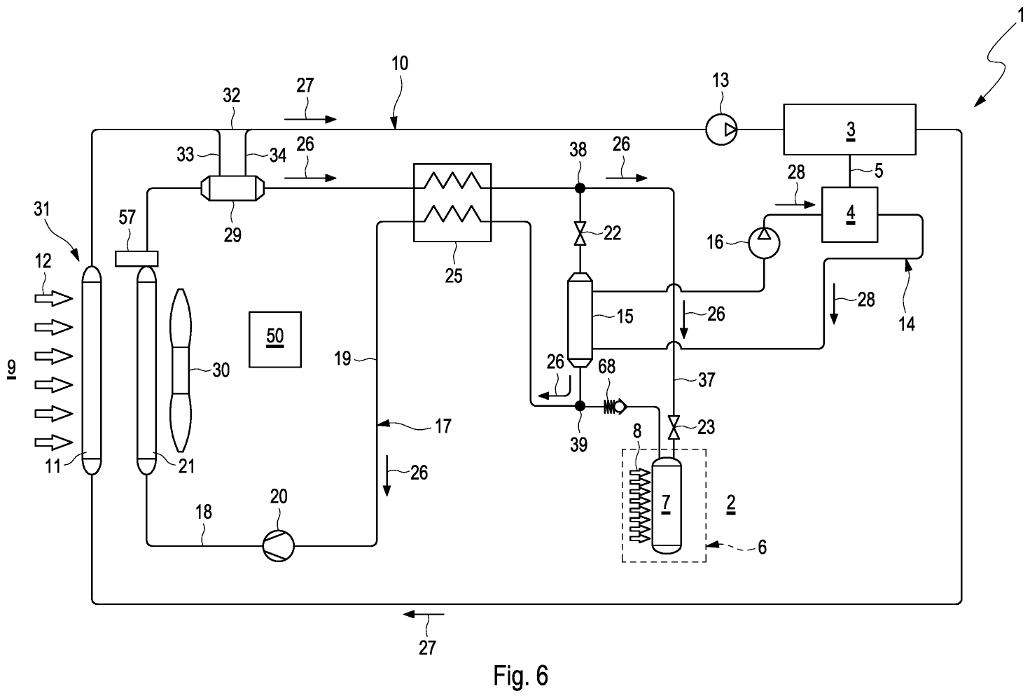

According to the FIGS. 7 and 8, the refrigeration circuit 17, here too, comprises an interior heater 43 which on the high-pressure side 18 has an advance 52 and a return 53. The advance 52 is connected to the compressor 20 while the return 53 is connected to a switching valve 54. In addition, a cooling path 55 and a heating path 56 are connected to the switching valve 54. The switching valve 54 can be switched over between a cooling position and a heating position. In the cooling position, the switching valve 54 conducts the refrigerant coming from the return 53 through the cooling path 55. In the heating position, the switching valve 54 conducts the refrigerant coming from the return 53 through the heating path 56. For this purpose, the switching valve 54 can practically be configured as 3/2-way valve. The cooling path 55 connects the switching valve 54 with the refrigerant cooler 21. The heating path 56 connects the switching valve 54 to a refrigerant collector 57. For this purpose, the heating path 56 is connected to a collector inlet 58. The refrigeration circuit 17 additionally comprises an after-cooling path 59 which connects the refrigerant cooler 21 with the refrigerant collector 57 and for this purpose is likewise connected with the collector inlet 58. In the after-cooling path 59, the after-cooler 29 and a non-non-return check valve 68 are arranged. The refrigeration circuit 17 additionally comprises an expansion path 60, which is connected with a collector outlet 61 of the refrigerant collector 57 and additionally with the after-cooling path 59, namely between the refrigerant cooler 21 and the after-cooler 29. In the expansion path 60, a further or third expansion valve 24 is arranged. A refrigerant collector 57 is also present in the embodiment shown in FIG. 6 and purely exemplarily arranged directly on the refrigerant cooler 21 there.

In addition to this, the refrigeration circuit 17 comprises a heat exchanging path 62, which connects the collector outlet 61 with the internal heat exchanger 25. Apart from this, the refrigeration circuit 17 has a bypass path 63 which connects a first branch point 64 with a second branch point 65 and which contains a stop valve 66 for blocking and opening the bypass path 63. The first branch point 64 is arranged on the cooling path 55 between the refrigerant cooler 21 and the switching valve 54. The second branch point 65 is arranged on the low-pressure side 19 between the internal heat exchanger 25 and the compressor 20.

For realising a cooling operation of the refrigeration circuit 17 and a heating operation of the refrigeration circuit 17, the control 50 can now activate in particular the switching valve 54 and the stop valve 66. The flow of refrigerant through the refrigeration circuit 17 is symbolised by the arrows 26 in FIG. 7 for the cooling mode and in FIG. 8 for the heating mode.

According to FIG. 7, the switching valve 54, for the cooling operation of the refrigeration circuit 17, which serves for cooling the battery coolant and/or for cooling the room air flow 8, is adjusted into its cooling position. At the same time, the stop valve 66 is adjusted into its blocking position. As a result, the refrigerant can flow from the compressor 20 through the advance 52, through the interior heater 43, through the return 53 to the switching valve 54, from there through the cooling path 55, through the refrigerant cooler 21, through the after-cooler path 59 and thus through the after-cooler 29 and to the refrigerant collector 57. From there, the refrigerant flows through the heat exchanging path 62, through the internal heat exchanger 25, then branches at the first branch-off point 38 into the battery cooler 55 and into the interior cooler 7 and unites at the first introduction point 39 and from there flows through the internal heat exchanger 25 back to the compressor 20. The expansion valve 24 is configured in the expansion path 60 so that it can be closed by the control 50 for the cooling operation. As a result, the expansion path 60 in the cooling mode is not flowed through in the wrong direction. The correct flow direction of the expansion path 60 or of the associated expansion valve 24 is present in the heating mode.

For the heating operation of the refrigeration circuit 17 according to FIG. 8, which serves for heating the room air flow 8, the switching valve 54 is adjusted into its heating position and the stop valve 66 into its open position. The refrigerant can now flow from the compressor 20 through the advance 52 to the interior heater 43 and from there through the return 53 to the switching valve 54. From the switching valve 54 the refrigerant then flows through the heating path 56 to the refrigerant collector 57. From there, the refrigerant flows on the one hand, in FIG. 7 to the left, through the expansion path 60. In the expansion valve 24 arranged therein, the refrigerant expands and with reduced pressure reaches the refrigerant cooler 21, which during the heating operation works as evaporator. In this way, the refrigerant can absorb heat and then flows from the refrigerant cooler 21 further along the cooling path 55 up to the first branch point 64 and from there through the bypass path 63 up to the second branch point 65. A flow of the refrigerant from the first branch point 64 to the switching valve 54 is prevented by the heating position, in which the switching valve blocks its connection to the cooling path 55. From the second branch point 65, the refrigerant then flows back to the compressor 20.

From the refrigerant collector 57, the refrigerant also flows, on the other hand, in FIG. 8 to the right, through the heat exchanging path 62 to the internal heat exchanger 25 and from there to the first branch-off point 38. There, the volume flow of the refrigerant splits up so that the refrigerant flows through the battery cooler 15 and the interior cooler 7 in parallel. The refrigerant again unites at the first introduction point 39 and from there flows through the internal heat exchanger 25 up to the second branch point 65. There, the refrigerant conducted through the battery cooler 15 and the interior cooler 7 unites with the refrigerant cooler 21 operating as evaporator. From the second branch point 65, the entire volume flow of the refrigerant then flows back to the compressor 20.

Further, non-non-return check valves 68 are provided in all embodiments in the refrigeration circuit 17 in a suitable position in order to prevent refrigerant flowing in the wrong direction.

The embodiments of the FIGS. 1 to 5 are designed purely exemplarily for a first refrigerant, such as for example R744 (CO2) while the embodiments of the FIGS. 6 to 8 are designed for a second refrigerant, such as for example R134a or R1234yf, which is distinct from the first refrigerant. The refrigerants differ by the temperatures at which the phase change takes place and have an effect in particular on the pressures, volume flows, heat flows in the refrigeration circuit.

1. A battery-electric vehicle, comprising:
a vehicle interior for at least one person,
an electric motor drivetrain,
a traction battery for the energy supply of the drivetrain,
an air-conditioning system for air-conditioning the vehicle interior, the air-conduction system including at least one interior cooler which for cooling a room air flow leading to the vehicle interior can be flowed through by the room air flow,
a drive cooling circuit carrying a drive coolant for cooling the drivetrain, the drive cooling circuit including a drive cooler that can be flowed through by the drive coolant and by a cooling air flow,
a battery cooling circuit carrying a battery coolant for cooling the traction battery, the battery cooling circuit including a battery cooler which can be flowed through by the battery coolant,
a refrigeration circuit carrying a refrigerant, the refrigeration circuit including a high-pressure side, a low-pressure side, a compressor for driving and compressing the refrigerant, a refrigerant cooler for cooling the refrigerant, at least one expansion valve for expanding the refrigerant and an internal heat exchanger,
wherein the internal heat exchanger couples the high-pressure side to the low-pressure side in a heat-transferring manner,
wherein the at least one expansion valve is connected on the inlet side to the high-pressure side and on the outlet side to the low-pressure side,
wherein the compressor is connected to the low-pressure side on the inlet side and to the high-pressure side on the outlet side,
wherein the refrigerant cooler can be flowed through by a cooling air flow and by the refrigerant and is arranged in the high-pressure side upstream of the internal heat exchanger,
wherein the battery cooler is incorporated in the refrigeration circuit downstream of the at least one expansion valve and upstream of the internal heat exchanger and can be flowed through by the refrigerant,
wherein the interior cooler is incorporated in the refrigeration circuit downstream of the at least one expansion valve and upstream of the internal heat exchanger and can be flowed through by the refrigerant,
wherein the refrigeration circuit additionally comprises an after-cooler which is arranged in the refrigeration circuit downstream of the refrigerant cooler and upstream of the internal heat exchanger and can be flowed through by the refrigerant, and
wherein the after-cooler is additionally incorporated in the drive cooling circuit downstream of the drive cooler and can be flowed through by the drive coolant.

2. The vehicle according to claim 1, wherein at least one of:
a cooling fan is provided which with stationary vehicle generates the cooling air flow and with travelling vehicle supports the cooling air flow,
the drive cooler and the refrigerant cooler are arranged in a front end of the vehicle,
the refrigerant cooler and the drive cooler are arranged so that they can be flowed through in succession by the same cooling air flow, and
the drive cooler with respect to the cooling air flow is arranged upstream of the refrigerant cooler on or in the vehicle.

3. The vehicle according to claim 1, wherein the after-cooler is incorporated in the drive cooling circuit so that the entire volume flow of the drive coolant flows through the after-cooler.

4. The vehicle according to claim 1, wherein the drive cooling circuit comprises an after-cooler bypass which bypasses the after-cooler, so that the volume flow of the drive coolant can at least partially flow through the after-cooler and/or at least partially through the after-cooler bypass.

5. The vehicle according to claim 4, wherein one of:
the drive cooling circuit comprises a stop valve arranged in the after-cooler bypass for blocking the after-cooler bypass as required,
the drive cooling circuit comprises a stop valve arranged in an inflow to the after-cooler for blocking the inflow as required, and
the drive cooling circuit comprises a stop valve arranged in an outflow from the after-cooler for blocking the outflow as required.

6. The vehicle according to claim 4, wherein the drive cooling circuit comprises a control valve with which a division of the volume flow of the drive coolant into the after-cooler and into the after-cooler bypass is adjustable.

7. The vehicle according to claim 1, wherein:
the refrigeration circuit comprises an interior cooling branch, in which the interior cooler is arranged,
the interior cooling branch branches off from the high-pressure side at a branch-off point, which is arranged in the high-pressure side downstream of the internal heat exchanger and upstream of the battery cooler, and
the interior cooling branch is returned at a return point into the low-pressure side, which is arranged in the low-pressure side downstream of the battery cooler and upstream of the internal heat exchanger.

8. The vehicle according to claim 7, wherein:
the refrigeration circuit comprises at least two expansion valves including a first expansion valve and a second expansion valve,
the first expansion valve is arranged downstream of the branch-off point and upstream of the battery cooler, and
the second expansion valve is arranged downstream of the branch-off point and upstream of the interior cooler.

9. The vehicle according to claim 1, wherein:
the refrigeration circuit comprises a bypass branch which bypasses the after-cooler, the internal heat exchanger on the high-pressure side and the battery cooler, and
the refrigeration circuit in the bypass branch comprises a stop valve for blocking and opening the bypass branch.

10. The vehicle according to claim 9, wherein:
the refrigeration circuit comprises a non-non-return check valve, which is arranged between a branch-off point, at which the bypass branch branches off upstream of the after-cooler, and the after-cooler and the blocking direction leads from the after-cooler in the direction of the branch-off point, and
the non-non-return check valve is preloaded into its blocking position with a preload that is selected so that the non-non-return check valve in its passage direction opens only from a predetermined opening pressure that is higher than the low pressure of the refrigeration circuit and lower than the high pressure of the refrigeration circuit.

11. The vehicle according to claim 9, wherein:
the refrigeration circuit comprises an interior heating branch, which in the high-pressure side branches off at a control valve which is arranged upstream of the refrigerant cooler and controls the volume flow of the refrigerant in the interior heating branch, and
the interior heating branch comprises an interior heater which can be flowed through by a room air flow and by the refrigerant.

12. The vehicle according to claim 11, wherein at least one of:
the interior cooler and the interior heater are arranged so that they can be flowed through by the same room air flow, and
the interior cooler with respect to the room air flow is arranged upstream of the interior heater in or on the vehicle.

13. The vehicle according to claim 11, wherein:
the refrigeration circuit comprises a connecting branch which via a first connecting point branches off from the high-pressure side, which is arranged in the high-pressure side downstream of the interior heater and upstream of the refrigerant cooler and via a second connecting point is introduced into the high-pressure side, which is arranged in the high-pressure side downstream of the internal heat exchanger and upstream of the interior cooler, and
the connecting branch comprises a control valve for adjusting a volume flow of the refrigerant through the connecting branch.

14. The vehicle according to claim 13, wherein:
in the refrigeration circuit between the first connecting point and the refrigerant cooler a controllable throttle valve is arranged, which can be switched between a throttling state and a passage state,
the throttle valve in the throttling state functions as further expansion valve, so that the high-pressure side connected thereto on the inlet side contains the interior heater and the low-pressure side connected thereto on the outlet side contains the refrigerant cooler,
the refrigerant cooler in the throttling state of the throttle valve functions as evaporator for heating the refrigerant, and
the throttle valve in the passage state can be flowed through by the refrigerant and is connected to the high-pressure side on the inlet side and on the outlet side.

15. The vehicle according to claim 1, wherein:
the refrigeration circuit comprises an interior heater, which on the high-pressure side comprises an advance and a return,
the advance of the interior heater is connected to the compressor,
the return of the interior heater is connected to a switching valve, which is additionally connected to a cooling path and to a heating path, which can be switched over between a cooling position and a heating position, the refrigerant coming from the return in the cooling position leads through the cooling path and the refrigerant coming from the return in the heating position leads through the heating path,
the cooling path leads from the switching valve to the refrigerant cooler,
the heating path leads from the switching valve to a collector inlet of a refrigerant collector on the high-pressure side,
the refrigeration circuit comprises an after-cooling path which leads from the refrigerant cooler to the collector inlet and in which the after-cooler is arranged,
the refrigeration circuit comprises an expansion path which contains an expansion valve, which is connected to a collector outlet of the refrigerant collector and which is connected to the after-cooling path between the refrigerant cooler and the after-cooler,
the refrigeration circuit comprises a heat exchanging path, which leads from the collector outlet to the internal heat exchanger,
the refrigeration circuit comprises a bypass path, which connects a first branch point, which is arranged on the cooling path between the refrigerant cooler and the switching valve, with a second branch point, which is arranged on the low-pressure side between the internal heat exchanger and the compressor, and
the bypass path comprises a stop valve which can be switched between a blocking position for blocking the bypass path and an open position for opening the bypass path.

16. The vehicle according to claim 15, wherein at least one of:
for a cooling operation of the refrigeration circuit for cooling the battery coolant and/or the room air flow, the switching valve is adjusted into its cooling position and the stop valve is adjusted into its blocking position, so that the refrigerant flows from the compressor through the interior heater, then through the cooling path, then through the refrigerant cooler, then through the after-cooler, then through the refrigerant collector, then through the internal heat exchanger, then through the battery cooler and/or through the interior cooler and then again to the compressor, and
for a heating operation of the refrigeration circuit for heating the room air, the switching valve is adjusted into its heating position and the stop valve into its open position, so that the refrigerant flows from the compressor through the interior heater, then through the heating path, then through the refrigerant collector, then through the expansion path, then through the refrigerant cooler, then through the bypass path and then again to the compressor.

17. The vehicle according to claim 2, wherein the after-cooler is incorporated in the drive cooling circuit so that the entire volume flow of the drive coolant flows through the after-cooler.

18. The vehicle according to claim 2, wherein the drive cooling circuit comprises an after-cooler bypass which bypasses the after-cooler, so that the volume flow of the drive coolant can at least partially flow through the after-cooler and/or at least partially through the after-cooler bypass.

19. The vehicle according to claim 10, wherein:
the refrigeration circuit comprises an interior heating branch, which in the high-pressure side branches off at a control valve which is arranged upstream of the refrigerant cooler and controls the volume flow of the refrigerant in the interior heating branch, and
the interior heating branch comprises an interior heater which can be flowed through by a room air flow and by the refrigerant.

20. The vehicle according to claim 12, wherein:
the refrigeration circuit comprises a connecting branch which via a first connecting point branches off from the high-pressure side, which is arranged in the high-pressure side downstream of the interior heater and upstream of the refrigerant cooler and via a second connecting point is introduced into the high-pressure side, which is arranged in the high-pressure side downstream of the internal heat exchanger and upstream of the interior cooler, and
the connecting branch comprises a control valve for adjusting a volume flow of the refrigerant through the connecting branch.
